(19) United States
(12) Patent Application Publication
(10) Pub. No.: US 2023/0247646 A1
(43) Pub. Date: Aug. 3, 2023

(54) PHYSICAL RESOURCE BLOCK BUNDLING SIZE RECOMMENDATION REPORTING

(71) Applicant: QUALCOMM INCORPORATED, San Diego, CA (US)

(72) Inventors: Michael LEVITSKY, Rehovot (IL); Alexandros MANOLAKOS, Escondido, CA (US); Peter GAAL, San Diego, CA (US); Chenxi HAO, Beijing (CN)

(21) Appl. No.: 18/003,553

(22) PCT Filed: Aug. 24, 2020
(86) PCT No.: PCT/CN2020/110717

§ 371 Date: Dec. 28, 2022

(51) Int. Cl. H04W 72/231; H04W 8/24

(52) U.S. Cl. CPC H04W 72/231; H04W 8/24

(57) ABSTRACT

Methods, systems, and devices for wireless communications are described. A user equipment (UE) may report a recommended physical resource block (PRB) bundling size to a network. For example, a UE may select a PRB bundling size based on one or more parameters that indicate channel characteristics of a channel. Upon selecting the PRB bundling size, the UE may transmit (e.g., as part of a channel state feedback (CSF) report) an indication of the selected PRB bundling size to a base station. The base station may use the indicated PRB bundling size to configure communications with the UE. In such cases, PRB bundling size assumptions for a reference resource may be aligned with the PRB bundling size indication included in a same CSF report. In some examples, the base station may configure CSF reporting that includes (or excludes) the PRB bundling size recommendation based on UE capabilities.

### CROSS REFERENCE

The present application is a 371 national stage filing of International PCT Application No. PCT/CN2020/110717 by LEVITSKY et al. entitled “PHYSICAL RESOURCE BLOCK BUNDLING SIZE RECOMMENDATION REPORTING,” filed Aug. 24, 2020, which is assigned to the assignee hereof, and which is expressly incorporated by reference in its entirety herein.

### FIELD OF TECHNOLOGY

The following relates to wireless communications, including physical resource block bundling size recommendation reporting.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support physical resource block (PRB) bundling size recommendation reporting. For example, a user equipment (UE) may select a PRB bundling size that is indicated to a network. In some aspects, the UE may determine parameters that are indicative of channel characteristics of a channel used to communicate with a base station. The UE may use the parameters for selecting a PRB bundling size, and the UE may transmit an indication of the selected PRB bundling size to the base station. In some examples, the indication of the selected PRB bundling size may be transmitted in a channel state feedback (CSF) report (e.g., including one or more of a channel quality indicator (CQI), precoding matrix indicator (PMI), a rank indicator (RI), or the like) or a CSF report that further includes an indication of a demodulation reference signal (DMRS) configuration (or a DMRS configuration change request bit). The base station may use the indicated PRB bundling size for communicating with the UE (e.g., for precoding resource group (PRG) size configuration which may define a precoding granularity in the frequency domain) and for configuring transmission parameters. In some examples, a PRB bundling size assumption for a channel state information (CSI) reference resource used for CSF evaluation and reporting may be aligned with the PRB bundling size recommended by the UE (e.g., in the same CSF report that corresponds to the CSF evaluation). As an example, when the UE transmits an indication of the recommended PRB bundling size (e.g., based on a configuration of a CSF report), the UE may assume a PRB bundling size for a CSI reference resource associated with CSF evaluation procedures, where the assumed PRB bundling size matches the recommended PRB bundling size indicated to the network (e.g., in the same CSF report). In other example, such as when a report is not configured for reporting a recommended PRB bundling size, the UE may assume a predetermined PRB bundling size. In any case, the base station may configure the reporting that includes (or excludes) the PRB bundling size recommendation based on a capability of the UE.

A method of wireless communication at a UE is described. The method may include determining one or more parameters that indicate channel characteristics of a channel for communicating with a base station, selecting a physical resource block bundling size based on the determined one or more parameters, and transmitting, to the base station, a report including an indication of the selected physical resource block bundling size.

An apparatus for wireless communication at a UE is described. The apparatus may include a processor, memory coupled with the processor, and instructions stored in the memory. The instructions may be executable by the processor to cause the apparatus to determine one or more parameters that indicate channel characteristics of a channel for communicating with a base station, select a physical resource block bundling size based on the determined one or more parameters, and transmit, to the base station, a report including an indication of the selected physical resource block bundling size.

Another apparatus for wireless communication at a UE is described. The apparatus may include means for determining one or more parameters that indicate channel characteristics of a channel for communicating with a base station, selecting a physical resource block bundling size based on the determined one or more parameters, and transmitting, to the base station, a report including an indication of the selected physical resource block bundling size.

A non-transitory computer-readable medium storing code for wireless communication at a UE is described. The code may include instructions executable by a processor to determine one or more parameters that indicate channel characteristics of a channel for communicating with a base station, select a physical resource block bundling size based on the determined one or more parameters, and transmit, to the base station, a report including an indication of the selected physical resource block bundling size.

Some examples of the method, apparatuses, and non-transitory computer-readable medium described herein may further include operations, features, means, or instructions for transmitting an indication of a UE capability for indicating the physical resource block bundling size, where selecting the physical resource block bundling size may be based on the UE capability.

Some examples of the method, apparatuses, and non-transitory computer-readable medium described herein may further include operations, features, means, or instructions for receiving, from the base station, a configuration of the report based on the indication of the UE capability, where transmitting the report including the indication of the selected physical resource block bundling size may be based on the configuration.

In some examples of the method, apparatuses, and non-transitory computer-readable medium described herein, receiving the configuration may include operations, features, means, or instructions for receiving radio resource control signaling including an information element that configures the report.

In some examples of the method, apparatuses, and non-transitory computer-readable medium described herein, receiving the configuration may include operations, features, means, or instructions for receiving a medium access control (MAC) control element that configures the report.

In some examples of the method, apparatuses, and non-transitory computer-readable medium described herein, the report includes a CSF report associated with a first CSI report identifier (ID), the CSF report being configured to include the indication of the selected PRB bundling size (e.g., a PRB bundling size recommendation). In some examples of the method, apparatuses, and non-transitory computer-readable medium described herein, the report may include operations, features, means, or instructions for using, as part of an evaluation of the CSF report, an assumption of a bundling size for a reference resource, wherein the assumption corresponds to the bundling size being the same as the selected PRB bundling size indicated by the report.

Some examples of the method, apparatuses, and non-transitory computer-readable medium described herein may further include operations, features, means, or instructions for identifying a configuration of a second report (e.g., a CSF report) associated with a second CSI report ID, the second report being configured to exclude the indication of the selected PRB bundling size based on a capability of the UE, and using, as part of an evaluation of the second report, an assumption of a predetermined bundling size for a second reference resource.

Some examples of the method, apparatuses, and non-transitory computer-readable medium described herein may further include operations, features, means, or instructions for identifying that the report is configured to include the indication of the selected physical resource block bundling size and further configured for subband channel state feedback reporting for at least one of a channel quality indicator, a precoding matrix indicator, or a demodulation reference signal configuration, determining (e.g., assuming) a subband size associated with the report based on the configuration, and transmitting, as part of the report, an indication of the channel quality indicator, the precoding matrix indicator, the demodulation reference signal configuration, or any combination thereof, based at least in part on the subband size and the configuration.

In some examples of the method, apparatuses, and non-transitory computer-readable medium described herein, the selected PRB bundling size includes a wideband physical resource block bundling size, the wideband physical resource block bundling size corresponding to the subband size associated with the report based on the configuration.

In some examples of the method, apparatuses, and non-transitory computer-readable medium described herein, a format of the report excludes a CSI report format that assumes a random precoding for report determination and may have a corresponding preconfigured precoding resource block group size for report evaluation.

In some examples of the method, apparatuses, and non-transitory computer-readable medium described herein, the indication of the selected physical resource block bundling size includes two or more bits of the report.

In some examples of the method, apparatuses, and non-transitory computer-readable medium described herein, transmitting the report may include operations, features, means, or instructions for transmitting the report periodically, aperiodically, or semi-persistently.

In some examples of the method, apparatuses, and non-transitory computer-readable medium described herein, selecting the physical resource block bundling size may include operations, features, means, or instructions for selecting the physical resource block bundling size from a set of physical resource block bundling sizes including at least a two resource block physical resource block bundling size, or a four resource block physical resource block bundling size, and a wideband physical resource block bundling size.

In some examples of the method, apparatuses, and non-transitory computer-readable medium described herein, the one or more parameters include a delay spread of the channel, an input signal-to-interference plus noise ratio, a post-processing signal-to-interference plus noise ratio, a channel estimation error floor, one or more precoding values, a precoding variability, one or more subbands, or any combination thereof.

In some examples of the method, apparatuses, and non-transitory computer-readable medium described herein, the report includes a channel state feedback report including a channel quality indicator, a precoding matrix indicator, a rank indicator, or any combination thereof.

In some examples of the method, apparatuses, and non-transitory computer-readable medium described herein, the channel state feedback report includes an indication of a demodulation reference signal configuration or a demodulation reference signal configuration change request.

A method of wireless communication at a base station is described. The method may include receiving, from a UE, a report including an indication of a physical resource block bundling size and determining a bundling size of a reference resource associated with a channel state feedback procedure based on the indication of the physical resource block bundling size.

An apparatus for wireless communication at a base station is described. The apparatus may include a processor, memory coupled with the processor, and instructions stored in the memory. The instructions may be executable by the processor to cause the apparatus to receive, from a UE, a report including an indication of a physical resource block bundling size and determine a bundling size of a reference resource associated with a channel state feedback procedure based on the indication of the physical resource block bundling size.

Another apparatus for wireless communication at a base station is described. The apparatus may include means for receiving, from a UE, a report including an indication of a physical resource block bundling size and determining a bundling size of a reference resource associated with a channel state feedback procedure based on the indication of the physical resource block bundling size.

A non-transitory computer-readable medium storing code for wireless communication at a base station is described. The code may include instructions executable by a processor to receive, from a UE, a report including an indication of a physical resource block bundling size and determine a bundling size of a reference resource associated with a channel state feedback procedure based on the indication of the physical resource block bundling size.

Some examples of the method, apparatuses, and non-transitory computer-readable medium described herein may further include operations, features, means, or instructions for receiving, from the UE, an indication of a UE capability for indicating the physical resource block bundling size, and transmitting, to the UE, a configuration of the report based on the indication of the UE capability, where receiving the report including the indication of the selected physical resource block bundling size may be based on the configuration.

Some examples of the method, apparatuses, and non-transitory computer-readable medium described herein may further include operations, features, means, or instructions for transmitting, to the UE, a configuration of a second report associated with a channel state information report identifier, the second report configured to exclude the indication of the physical resource block bundling size based on the indication of the UE capability.

In some examples of the method, apparatuses, and non-transitory computer-readable medium described herein, transmitting the configuration may include operations, features, means, or instructions for transmitting radio resource control signaling including an information element that configures the report.

In some examples of the method, apparatuses, and non-transitory computer-readable medium described herein, transmitting the configuration may include operations, features, means, or instructions for transmitting a medium access control (MAC) control element that configures the report.

Some examples of the method, apparatuses, and non-transitory computer-readable medium described herein may further include operations, features, means, or instructions for precoding one or more allocated resources in accordance with the indicated physical resource block bundling size, where the report includes a CSF report associated with a CSI report ID having a configuration for PRB bundling size reporting.

Some examples of the method, apparatuses, and non-transitory computer-readable medium described herein may further include operations, features, means, or instructions for receiving, as part of the report, an indication of a channel quality indicator, a precoding matrix indicator, a demodulation reference signal configuration, or any combination thereof, based on a configured subband size associated with the report

In some examples of the method, apparatuses, and non-transitory computer-readable medium described herein, the indicated physical resource block bundling size includes a wideband physical resource block bundling size, and where the wideband physical resource block bundling size may be interpreted as matching the configured subband size associated with the report.

In some examples of the method, apparatuses, and non-transitory computer-readable medium described herein, a format of the report excludes a CSI report format that assumes a random precoding for report determination and may have a corresponding preconfigured precoding resource block group size for report evaluation.

In some examples of the method, apparatuses, and non-transitory computer-readable medium described herein, the indication of the physical resource block bundling size includes two or more bits of the report.

In some examples of the method, apparatuses, and non-transitory computer-readable medium described herein, receiving the report may include operations, features, means, or instructions for receiving the report periodically, aperiodically, or semi-persistently.

In some examples of the method, apparatuses, and non-transitory computer-readable medium described herein, the physical resource block bundling size may be from a set of physical resource block bundling sizes including at least a two resource block physical resource block bundling size, or a four resource block physical resource block bundling size, and a wideband physical resource block bundling size.

In some examples of the method, apparatuses, and non-transitory computer-readable medium described herein, the physical resource block bundling size may be based on one or more parameters including a delay spread of the channel, an input signal-to-interference plus noise ratio, a post-processing signal-to-interference plus noise ratio, a channel estimation error floor, one or more precoding values, a precoding variability, one or more subbands, or any combination thereof.

In some examples of the method, apparatuses, and non-transitory computer-readable medium described herein, the report includes a channel state feedback report including a channel quality indicator, a precoding matrix indicator, a rank indicator, or any combination thereof.

In some examples of the method, apparatuses, and non-transitory computer-readable medium described herein, the channel state feedback report includes an indication of a demodulation reference signal configuration or a demodulation reference signal configuration change request.

### BRIEF DESCRIPTION OF THE DRAWINGS

FIG. 1 illustrates an example of a wireless communications system that supports physical resource block bundling size recommendation in accordance with aspects of the present disclosure.

FIG. 2 illustrates an example of a wireless communications system that supports physical resource block bundling size recommendation reporting in accordance with aspects of the present disclosure.

FIG. 3 illustrates an example of a process flow in a system that supports physical resource block bundling size recommendation reporting in accordance with aspects of the present disclosure.

FIGS. 4 and 5 show block diagrams of devices that support physical resource block bundling size recommendation reporting in accordance with aspects of the present disclosure.

FIG. 6 shows a block diagram of a communications manager that supports physical resource block bundling size recommendation reporting in accordance with aspects of the present disclosure.

FIG. 7 shows a diagram of a system including a device that supports physical resource block bundling size recommendation reporting in accordance with aspects of the present disclosure.

FIGS. 8 and 9 show block diagrams of devices that support physical resource block bundling size recommendation reporting in accordance with aspects of the present disclosure.

FIG. 10 shows a block diagram of a communications manager that supports physical resource block bundling size recommendation reporting in accordance with aspects of the present disclosure.

FIG. 11 shows a diagram of a system including a device that supports physical resource block bundling size recommendation reporting in accordance with aspects of the present disclosure.

FIGS. 12 through 15 show flowcharts illustrating methods that support physical resource block bundling size recommendation reporting in accordance with aspects of the present disclosure.

### DETAILED DESCRIPTION

In wireless communications systems, feedback reporting (e.g., channel state information (CSI) or channel state feedback (CSF) reporting) by a user equipment (UE) may provide information regarding a recommended configuration for a transmission on a communications link between the UE and a base station. For example, CSI may include information determined by a UE, where the information may include transmission parameters that are determined based on estimated channel and reception conditions over the communications link (e.g., a rank indicator (RI), a precoding matrix indicator (PMI), a channel quality indicator (CQI), or the like). In some cases, a UE may transmit CSI reports to a base station to provide information required for subsequent scheduling and transmissions. Feedback reporting may be periodic or aperiodic (e.g., triggered by signaling from a base station). In other examples, feedback reporting may be performed semi-persistently. A channel state information reference signal (CSI-RS) may be used (e.g., processed) by a UE to estimate channel quality between a base station and UE, and the UE may transmit a CSI report to the base station indicating recommended transmission parameter (e.g., for a physical downlink shared channel (PDSCH)).

Additionally, reference signals may be used to determine an estimate of a channel, as well as channel and demodulation parameters, to maintain a reliable and efficient link between wireless devices. For example, a demodulation reference signal (DMRS) may be used to determine an estimate of a data channel (e.g., a PDSCH or a physical uplink shared channel (PUSCH)) and to assist in the demodulation and decoding of signals received over the data channel. DMRS configurations used by a UE may be determined, for example, based on radio resource control (RRC) signaling. In some cases, changes in channel conditions that occur after a DMRS configuration is signaled may cause a DMRS configuration to use excessive resources without providing any increase in a spectral efficiency or link efficiency of communication to a UE. In other examples, a change in channel conditions may cause a selected DMRS configuration to use insufficient resources for optimizing a link efficiency in communications to a wireless device. As such, a UE may report a preferred DMRS configurations that is identified by the UE and signaled to a base station for adapting to short-term changes in channel and reception conditions. As an example, a UE may use a determined set of channel characteristics and an estimated link quality to estimate link quality characteristics that correspond to multiple DMRS configurations. The UE may then use the estimated link quality characteristics to identify a DMRS configuration from the multiple DMRS configurations for subsequent communications.

UE CSI feedback processing may be based on a CSI reference resource (e.g., a virtual resource) that may be used as a common basis for assumptions in interpreting feedback reports (e.g., at a base station) and for assumptions for feedback evaluations (e.g., at a UE). For example, a reference resource (e.g., a CSI reference resource) may be defined by a set of resource blocks corresponding to a radio frequency band in which a feedback value (e.g., a CQI value) relates, and the reference resource may be further defined by a slot (e.g., a single downlink slot) in the time domain. In some cases, when performing a channel feedback evaluation, a UE may assume a predetermined physical resource block (PRB) bundling size for a reference resource. A PRB bundling size may correspond to a level of granularity of precoding (e.g., for a number of contiguous PRBs of a PDSCH transmission having the same precoding) or correspondingly, the length, in resource block (RBs), that the UE may assume that precoding over the PRBs does not change in addressed transmissions from another device (e.g., a base station). In some examples, a UE may utilize a predetermined or default assumption of a PRB bunding size of two (2) PRBs for a CSI reference resource for CSI evaluations.

This assumption of the PRB bundling size for the reference resource, however, may not be aligned with dynamically changing channel conditions and achievable levels of channel estimation errors. In particular, the predetermined PRB bundling size may be selected by the UE without regard for measured or estimated channel characteristics. Further, the assumption of a fixed or predetermined PRB bunding size may increase channel estimation error by limiting the channel coherence bandwidth range and, consequently, limiting the channel estimation filter length. In addition, using the predetermined PRB bundling size may result in the UE selecting a more dense DMRS pattern (e.g., corresponding to a DMRS configuration) to obtain a level of channel estimation accuracy for optimizing link efficiency. For example, link efficiency may be increased through improvements in channel estimation accuracy, and selecting a relatively more dense DMRS configuration with minimum PRB bundling size assumptions may result in relatively lower spectral efficiency than what may be achieved if PRB bundling size consideration are taken in account (e.g., adaptively) on top of existing channel and reception conditions. In addition, in cases where techniques for adaptive DMRS configuration selection is used, there may be a higher sensitivity for an accurate prediction of the channel estimation error floor associated with the assumed DMRS configuration. Here, PRB bundling size may be one of the parameters impacting a processing gain involved in channel estimation and it may be beneficial to accurately and adaptively select a PRB bundling size based on the channel conditions to allow more accurate DMRS configuration selection. In cases where DMRS adaptation is assumed, channel feedback techniques that coexist (and are consistent) with dynamically changing DMRS configurations may be preferred. Using techniques that enable enhanced channel estimation accuracy (with adaptively selected PRB bundling size configuration) may generally improve channel feedback accuracy as well as the corresponding link efficiency.

As described herein, a UE may select a PRB bundling size based on one or more parameters that indicate channel characteristics of a channel, and the UE may indicate the selected PRB bundling size to the network. In such cases, the PRB bundling size may be reported in a CSF report or a joint DMRS and CSF report (e.g., including CSI and an indication of a DMRS configuration). In such cases, the CSF report may be a non-beam management type CSF report. For example, the CSF report may be a report that is not configured with a report quantity for cri-RSRP, or the CSF report may be a report that is not configured with a report quantity for ssb-index-RSRP). The one or more parameters used to select the PRB bundling size may include a delay spread, a post-processing signal-to-interference plus noise ratio (SINR), an input SINR, a channel estimation error floor, one or more precoding values, a precoding variability (e.g., as a function of frequency), one or more subbands, or any combination thereof. A base station may configure the UE to report the selected PRB bundling size, which may be based on a capability of the UE. For example, the UE may indicate that it is capable of selecting a PRB bundling size, and the network may configure the wireless device with a CSF report (e.g., associated with a CSI report identifier (ID)) that is configured to indicate a selected PRB bundling size. In other examples, the UE may be configured with a CSF report that may not require the UE to report the PRB bundling size (which may be based on the UE's capabilities). Based on reporting the PRB bundling size in a configured report, when the UE performs a subsequent channel feedback evaluation the UE may assume that the PRB bundling size for the reference resource may match the PRB bundling size reported by the UE in the same report. Alternatively, if the UE is not configured to report the PRB bundling size, the UE may utilize a predetermined assumption for the PRB bundling size (e.g., two PRBs).

The reported PRB bundling size may not limit the coherence bandwidth range of the channel and consequently, and may also not limit the length of the channel estimation filter. Additionally, the one or more parameters may already be available to a UE through various channel estimation procedures, and the UE may accordingly determine the PRB bundling size without additional processing or acquiring additional information on the channel. In some cases, the UE, configured to select and report PRB bundling size, may determine the channel coherence bandwidth range and working SNR point of the link and also optimal precoding variability in frequency domain and select the most appropriate PRB size that will maximize link efficiency. By using the described techniques, a UE may achieve accurate CSF reporting (e.g., using an adaptive PRB bundling size), which may correspond to a more efficient link obtained with adaptive PRG sizes that follow the UE's reported recommendation. In addition, based on one or more channel characteristics and the estimated channel and reception conditions, the wireless device may determine an appropriate DMRS configuration based on the PRB bundling size assumption, which may result in relatively higher spectral efficiency, for example, compared to a DMRS configuration selection based on a fixed PRB bundling size assumption.

Aspects of the disclosure are initially described in the context of wireless communications systems. Further aspects are then described with reference to a process flow that illustrates examples of reporting a recommended PRB bundling size. Aspects of the disclosure are further illustrated by and described with reference to apparatus diagrams, system diagrams, and flowcharts that relate to physical resource block bundling size recommendation reporting.

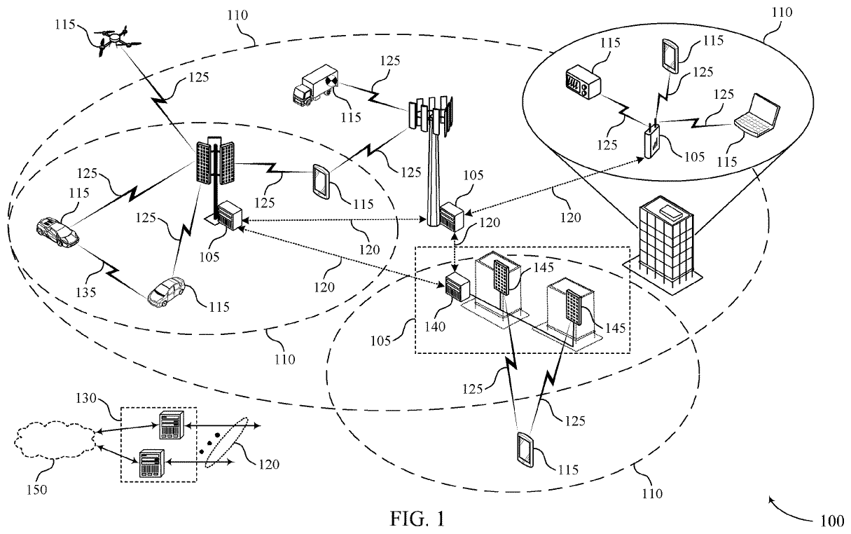

FIG. 1 illustrates an example of a wireless communications system 100 that supports physical resource block bundling size recommendation reporting in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a subband, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may include one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to the network operators IP services 150. The network operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, for example, in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more subbands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A base station 105 may gather channel condition information from a UE 115 in order to efficiently configure schedule the channel. This information may be sent from the UE 115 in the form of a channel state report (or CSI report). In some cases, channel state information may be reported in a CSF report. A channel state report may contain a rank indicator (RI) requesting a number of layers to be used for downlink transmissions (e.g., based on antenna ports of the UE 115), a PMI indicating a preference for which precoder matrix should be used (e.g., based on a number of layers), and a channel quality indicator (CQI) representing a highest modulation and coding scheme (MCS) that may be used. CQI may be calculated by a UE 115 after receiving predetermined pilot symbols such as CRS or CSI-RS. RI and PMI may be excluded if the UE 115 does not support spatial multiplexing (or is not in a supported spatial mode). In some examples, the types of information included in the CSI report determines a reporting type. Channel state reports may be periodic, aperiodic, or semi-persistent. A UE may receive signaling from a base station configuring feedback reports (e.g., periodic CSI (P-CSI) for beam reporting, P-CSI for CSI reporting, etc.) and/or a UE may receive a trigger (e.g., a CSI trigger) from a base station for an aperiodic feedback report (e.g., aperiodic CSI (A-CSI)). In some examples, channel reporting may be configured by a base station 105 using, for example, RRC signaling, a MAC-CE, or any combination thereof. Additionally, CSI-RS resources may be measured by a UE 115 to estimate channel quality of a CSI reference resource slot and may be indicated by measured channel quality parameters (e.g., CQI, PMI, RI, layer 1-reference signal received power (L1-RSRP)). The UE 115 may transmit a CSI report to the base station 105 indicating the measured channel quality parameters for the CSI reference resource slot. In some cases, the base station 105 may use the CSI report for future scheduling.

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

Wireless communications system 100 may support PRB bundling size recommendation reporting by a UE 115. For example, a UE 115 may select a PRB bundling size that is indicated to a network. In some aspects, the UE 115 may determine parameters that are indicative of channel characteristics of a channel used to communicate with a base station 105. The UE 115 may use the parameters for selecting a PRB bundling size, and the UE 115 may transmit an indication of the selected PRB bundling size to the base station 105. In some examples, the indication of the selected PRB bundling size may be transmitted in a CSF report (e.g., including one or more of a CQI, PMI, an RI, or the like) or a CSF report that further includes an indication of a DMRS configuration (or a DMRS configuration change request bit). The base station 105 may use the indicated PRB bundling size for communicating with the UE 115, which may include the use of a common assumption (e.g., between the UE 115 and base station 105) regarding a PRB bundling size for a CSI reference resource used for CSF evaluation and reporting. In some cases, the base station may indicate a precoding resource group (PRG) size configuration which may define precoding granularity in the frequency domain. In some examples, a PRB bundling size assumption for a CSI reference resource used for CSF evaluation and reporting may be aligned with the PRB bundling size recommended by the UE (e.g., in the same CSF report that corresponds to the CSF evaluation). As an example, when the UE 115 transmits an indication of the recommended PRB bundling size (e.g., based on a configuration of a CSF report), the UE 115 may assume a PRB bundling size for a CSI reference resource associated with CSF evaluation procedures, where the assumed PRB bundling size matches the recommended PRB bundling size indicated to the network in the same CSF report. In other example, such as when a report is not configured for reporting a recommended PRB bundling size, the UE 115 may assume a predetermined PRB bundling size. In any case, the base station 105 may configure the reporting that includes (or excludes) the PRB bundling size recommendation based on a capability of the UE 115.

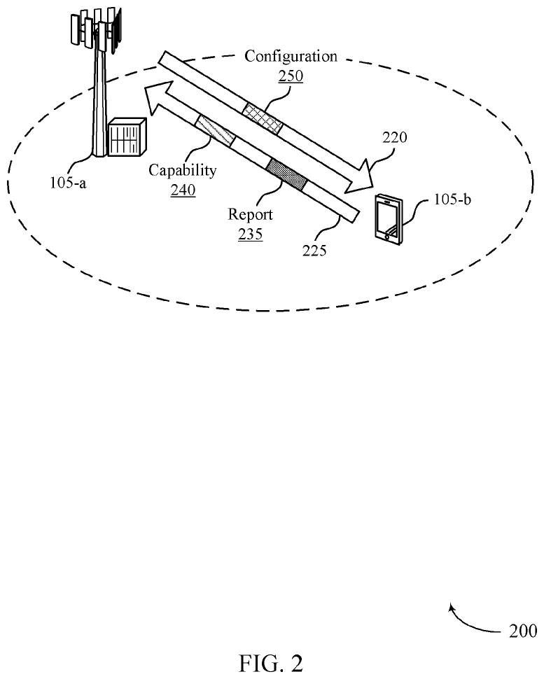

FIG. 2 illustrates an example of a wireless communications system 200 that supports physical resource block bundling size recommendation reporting in accordance with aspects of the present disclosure. In some examples, wireless communications system 200 may implement aspects of wireless communications system 100. For example, wireless communications system 200 includes a base station 105-a and UE 115-a, which may be respective examples of a base station 105 and a UE 115 described with reference to FIG. 1. Base station 105-a and UE 115-a may communicate with one another over downlink 220 and uplink 225, which may be examples of communication links (e.g., communication links 125 described with reference to FIG. 1) within a coverage area.

In some examples, wireless communications system 200 may support adaptive DMRS configuration and channel estimation accuracy for communications between UE 115-a and base station 105-a may be based on a level of correlation of the channel in time and frequency, working signal-to-noise ratio (SNR) point of UE 115-a, and may further be based on a DMRS configuration. Channel parameters and SNR conditions may be different at different locations and may be time varying, and different channel and SNR conditions may accordingly correspond to different DMRS configurations for maximizing spectral efficiency of the link between UE 115-a and base station 105-a. In some cases, using a fixed DMRS configuration may require a trade-off between overhead associated with DMRS and UE 115-a performance.

Wireless communications system 200 may thus support techniques that adapt DMRS configurations (e.g., per slot) to align with channel conditions between UE 115-a and base station 105-a. The DMRS configuration may be adapted based on one or more channel parameters, SNR conditions, or both. As such, UE 115-a may perform one or more channel estimation procedures to determine DMRS configuration recommendations (or DMRS configuration change requests). In some cases, the accuracy of the DMRS configuration selection and the selected preference may be based at least in part on the estimated channel estimation error floor (accuracy).

In some examples, channel estimation accuracy for the link between UE 115-a and base station 105-a may be based on (or dependent on) a PRB bundling size. For example, PRB bundling for PDSCH may be semi-statically configured (e.g., via RRC) signaling in case of static bundling configuration for PDSCH. A PRB bundling size may be dynamically signaled to UE 115-a (e.g., via DCI) in cases of dynamic bundling configurations. In the frequency domain, the options for PRB bundling size may include, for example, two (2) PRBs, four (4) PRBs, or wideband (e.g., corresponding to an allocated bandwidth). Other PRB bundling sizes may be possible. In some examples, the selection of PRB bundling size may be based at least in part on delay spread or channel coherence bandwidth.

For channel feedback procedures (e.g., CSF reporting) in wireless communications system 200, UE 115-a may perform CSI feedback report evaluation based on a CSI reference resource (e.g., a virtual reference resource) used as a common basis for assumptions in interpreting feedback reports at a base station 105-a and for assumptions for the CSI feedback evaluations by UE 115-a. The reference resource (e.g., a CSI reference resource) may be defined by a set of resource blocks corresponding to a radio frequency band in which a feedback value (e.g., a CQI value) relates, and the reference resource may be further defined by a slot (e.g., a single downlink slot) in the time domain. In some cases, when performing CSI feedback evaluation, UE 115-a may assume a fixed or predetermined PRB bundling size for a CSI reference resource. The PRB bundling size may correspond to a level of granularity of precoding (e.g., a number of contiguous PRBs of a PDSCH transmissions having the same precoding) or put another way, a length in RBs that UE 115-a may assume that precoding may not change over the PRBs for transmissions from base station 105-a. As an example, UE 115-a may assume a predetermined PRB bunding size of two (2) PRBs for a CSI reference resource.

Such PRB bundling size assumptions, however, may limit a channel estimation filter length/width (e.g., in frequency domain) and channel estimation accuracy. This limitation may be due to a channel estimation filter length being defined by a channel coherence bandwidth, which may also assume a constant precoding within the coherence bandwidth. Because the coherence bandwidth may be defined based on channel characteristics, such as a delay spread, it may be preferable for the PRB bundling size to correspond to the same channel characteristics. Using the fixed or predetermined PRB bundling size assumption (e.g., two RBs for a reference resource), however, may limit CSF feedback accuracy and correspondingly decrease a communication link efficiency.

As an illustrative example, in the case of a high-coherence bandwidth (e.g., a flat channel), using a maximum channel estimation filter length (e.g., in the frequency domain) may provide improved channel estimation accuracy. But this may not be taken in account by a UE 115-a for CSF evaluation when there is an assumption for CSI reference resource regarding a predetermined PRB bundling size of two RBs. In other examples, PDSCH processing at UE 115-a may be based on the PRB bundling size configuration. For instance, a PRB bundling size may be configured for a wideband parameter, and UE 115-a may use a maximum filter length that is available. But in order for CSF reporting to be compliant with some definitions used by the network, UE 115-a may only be able to assume a PRB bundling size of two PRBs, which may in some cases provide an assumption that increases channel estimation error, thereby causing a lower estimated spectral efficiency (e.g., leading to determining a CQI index that may be different from an optimal CQI index).

In addition, DMRS configuration selection by UE 115-a may attempt to identify an optimal tradeoff between channel estimation error (or accuracy) and DMRS overhead that may be translated to improved link/spectral efficiency of the channel. Here, channel estimation procedures may benefit from a DMRS configuration that maximizes a DMRS density (e.g., at least in the frequency domain) or assumes DMRS boosting (that increases effective code rate of the allocation), which may allow, for example, a maximum processing gain and minimum channel estimation error, leading to improved channel/link efficiency. On the other hand, there may be a penalty in terms of increased overhead for DMRS allocation, and there may accordingly be a tradeoff between channel estimation accuracy and pilot signal overhead. In such cases, channel estimation error projections may be identified, and different DMRS configuration may be tested. For example, channel estimation errors may be estimated for different DMRS configurations for some channel conditions. However, it may be possible to derive a misleading or inaccurate channel estimation error (e.g., based on a predetermined PRB bundling size), and a DMRS configuration having an increased density (e.g., relatively more dense pilots than needed) may be selected. In such cases, the predefined or fixed PRB bundling size (e.g., two RBs) may be a limiting factor for accuracy of DMRS selection procedures. As such, by using a PRB bundling size that is relatively more accurate with relation to the channel conditions, then predicted channel estimation error may be reduced, and selection of DMRS configurations that are more dense than necessary may be avoided.

As described herein, UE 115-a may support PRB bundling size recommendation reporting in accordance with one or more aspects of this disclosure. As an example, UE 115-a may determine a PRB bundling size and report the determined PRB bundling size to base station 105-a via PRB bundling size reporting 235 (e.g., a CSF report). UE 115-a may select a PRB bundling size option as a part of a CSF evaluation procedure. The PRB bundling size selection may be based at least in part on an estimation of channel characteristics, operational signal-to-interference plus noise ratio (SINR), optimal precoding variability (e.g., in the frequency domain), or the like. For example, UE 115-a may use various parameters related to channel conditions (e.g., a delay spread of a channel, an input SINR, a post-processing SINR, a channel estimation error floor, one or more precoding values, a precoding variability as a function of frequency, one or more subbands, or the like) that are already available at UE 115-a for CSF evaluation. As such, UE 115-a may have information that may be used to determine an optimal selection for PRB bundling size that may be used (e.g., by base station 105-a). For example, the PRB bundling size may be selected to be wideband in context of the allocation bandwidth or in context of per-subband CSF reporting, if configured, or may additionally or alternatively be reported to be defined by relatively smaller portions of radio frequency (RF) spectrum. Put another way, UE 115-a may have information for making an informed determination on the PRB bundling size.

UE 115-b may transmit the PRB bundling size reporting 235 to base station 105-b periodically, aperiodically, or semi-persistently. The PRB bundling size reporting 235 may be an example of a CSF report (e.g., including CQI, PMI, RI, and the like). Additionally or alternatively, the PRB bundling size reporting 235 may be an example of a joint CSF and DMRS report (e.g., a report including CSF values (from the CSF evaluation based on the selected PRB bundling size) and an indication of a DMRS configuration or a DMRS configuration change request), that is, UE 115-a may report the most convenient DMRS configuration option or alternatively may add a DMRS configuration change request bit to the reported CSF. In some cases, the PRB bundling size reporting 235 may be an example of a CSI report (e.g., a non-beam management CSI report or a non-RSRP report), and additional bits may be used in the CSI report format to enable UE 115-a to report the PRB bundling size. For example, two (2) bits may be included in the PRB bundling size reporting 235 for the indication of PRB bunding size.

PRB bundling size reporting, via the PRB bundling size reporting 235, may be utilized for various CSF reporting types, including periodic, aperiodic, or semi-periodic CSF reporting. The PRB bundling size reporting 235 including the PRB bundling size may also use a format that corresponds to various CSF reporting formats, but may exclude a CSF or CSI report format that assumes a random precoding for report determination and has a corresponding preconfigured precoding resource block group (PRG) size for report evaluation (e.g., a “cri-RI-i1-CQI” report). As an example, a “cri-RI-i1-CQI” report may be a report that assumes a random i2 precoding selection per precoding resource group (PRG) and has a dedicated PRG size configuration for this type of report for a corresponding CSI report ID. For aperiodic reporting, an extended CSF and DMRS report may be used with an option for reporting of more than a single DMRS and CQI bundle to allow a better flexibility to align with instant network scheduling constraints.

In some examples, the configuration of the PRB bundling size reporting 235 for reporting a recommended PRB bundling size may be based on one or more capabilities of UE 115-a. For example, UE 115-a may transmit an indication of UE capabilities 240 over uplink 225 to base station 105-a. The indication of UE capabilities 240 may indicate that UE 115-a is capable of PRB bundling size recommendation reporting. The capability of UE 115-a to report the PRB bundling size may be addressed as an additional UE capability. Base station 105-a may use the indication of UE capabilities 240 to configure PRB bundling size reporting 235 for one or more CSI report IDs. In such cases, a configuration of the PRB bundling size (e.g., to include in PRB bundling size reporting 235) may be included as a configuration field under CSI-ReportConfig information element (e.g., via RRC signaling). Base station 105-a may accordingly transmit a configuration 250 for the PRB bundling size reporting 235 to UE 115-a. The configuration 250 may configure UE 115-a to report a PRB bundling size recommendation for a CSI report ID. UE 115-a may be configured to report a selected PRB bundling size as part of a CSF report or a joint DMRS and CSF report if the PRB bundling size is configured for the corresponding CSI report ID. In such cases, for a CSI report ID that has a configured reporting of the PRB bundling size, UE 115-a may assume (e.g., for a CSI reference resource) a PRB bundling size that matches a reported PRB bundling size. In other examples, if a CSI report ID does not include a configuration for reporting the PRB bundling size, UE 115-a may assume (for the CSI reference resource) a predetermined PRB bundling size (e.g., two PRBs)

In some cases, when subband CQI, PMI, and/or DMRS reporting is configured, wideband PRB bundling size recommendation may be reported in context of the configured subband size. For example, when subband CSI reporting is configured, and when a PRB bundling size reporting is included in the corresponding CSI report (e.g., the PRB bundling size reporting 235), in the case where UE 115-a reports a “wideband” PRB bundling size, this PRB bundling size may be interpreted as being equal to the configured subband size. In such cases, if all or part of the PRB bundling size reporting 235 includes values associated with subband reporting (e.g., subband PMI), then a reported PRB bundling size may match the configured subband size even if the reported value is “wideband.” In such cases, once a subband PMI value is reported, it may be assumed that PMI is different per subband, and the PRB bundling size, even if reported as “wideband” may be reported as corresponding to the subband size in the same report.

Base station 105-a may use the indication of PRB bundling size transmitted by UE 115-a in PRB bundling size reporting 235 to configure communications between base station 105-a and UE 115-a. For example, base station 105-a may communicate with UE 115-a on allocated resources using a precoding configuration based on the PRB bundling size indication. In addition, base station 105-a may adjust transmission configurations (e.g., code rate/MCS adjustments) for some resource allocations having a corresponding allocation size, DMRS configuration, transport block (TB) size, or the like, based on the information provided by a UE CSF report that is addressed as a basis for adjustments assuming PRB bundling size matching the reported in the CSF report PRB bundling size. Correspondingly, base station 105-a may determine a PRB bundling size for a CSI reference resource that is based on the reported PRB bundling size. Reference resource assumptions may be applicable for a predefined allocation scenario (e.g., where a common reference for adjustments may not match an actual allocation by a scheduler) and, in other examples, some adjustments to the reported CQI may be used. The PRB bundling size assumption may also be taken into account for considerations related to PRB bundling size. For example, in cases that base station 105-a may not follow the recommendation of the reported PRB bundling size (e.g., including in PRB bundling size reporting 235), base station 105-a may scale (e.g., backoff) the included report parameters (e.g., CQI) in some way based on the knowledge of what was assumed in the context of PRB bundling size for the CSF report evaluation performed by UE 115-a.

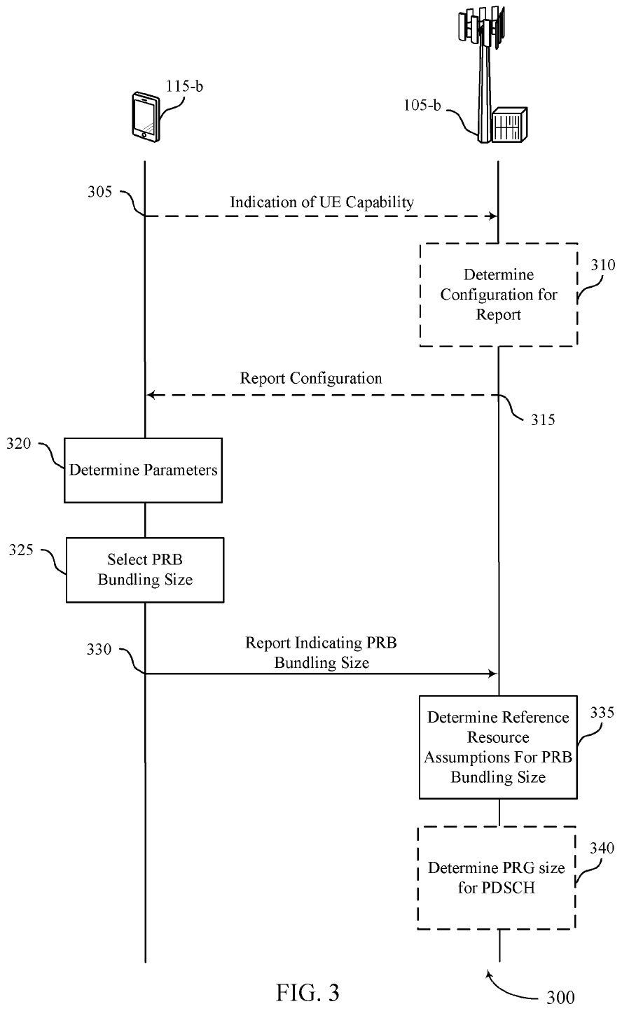

FIG. 3 illustrates an example of a process flow 300 in a system that supports physical resource block bundling size recommendation reporting in accordance with aspects of the present disclosure. In some examples, the process flow 300 may implement aspects of wireless communications systems 100 and 200. For example, the process flow 300 may be implemented by base station 105-b and UE 115-b, which may be respective examples of a base station 105 and UE 115 described herein, for example, with reference to FIG. 1. In the following description of the process flow 300, the information communicated between base station 105-b and UE 115-b may be performed in different orders or a different times. Some operations may also be omitted from the process flow 300 and other operations may be added to the process flow 300.

At 305, UE 115-b may transmit an indication of a UE capability for providing an indication of a preferred PRB bundling size. For instance, UE CSI feedback processing capability of UE 115-b may be based on CSI processing units (CPUs) available to UE 115-b for feedback processing operations (e.g., for performing channel measurements, processing feedback, generating a CSI feedback report, and the like). In some examples, UE 115-b may be capable of the simultaneously processing of some number of CSI reports (e.g., CSI calculations). For example, in some cases, the number of CPUs may be equal to the number of CSI calculations that UE 115-b is capable of concurrently processing. Further, UE 115 feedback processing capability may be based on a type of feedback reporting (e.g., CSI reporting), whether the feedback reporting is periodic or aperiodic, etc. As such, a UE 115 may be have varying CSI feedback processing capabilities (e.g., in how UE 115-b distributes processing capabilities, or CPUs, across feedback processing operations such as CSI calculations, feedback report generation, etc.). Further, the UE capability may generally include or provide information regarding one or more capabilities that are supported (or not supported) by UE 115-b. In some examples, the UE capability may include a capability for selecting and reporting a PRB bundling size to base station 105-b.

At 310, base station 105-b may determine a configuration for a report based on the indication of the UE capability received from UE 115-b (e.g., at 305). In particular, base station 105-b may determine a configuration for a report that includes an indication of a selected PRB bundling size (e.g., for a particular CSI report ID), based on the corresponding indication of a UE capability. In other examples, base station 105-b may configure a CSF report that does not include the indication of the PRB bundling size, which may be based on the capabilities of UE 115-b.

At 315, base station 105-b may transmit, to UE 115-b, a configuration of the report determined at 310. In some examples, base station 105-b may transmit the configuration via RRC signaling that includes an information element (e.g., a CSI-ReportConfig information element) that configures the report.

At 320, UE 115-b may determine one or more parameters that indicate channel characteristics of a channel for communicating with base station 105-b. In some cases, the one or more parameters may include a delay spread of the channel, a post-processing SINR, an input SINR, a channel estimation error floor, one or more precoding values, a precoding variability as a function of frequency, one or more subbands, or any combination thereof.

At 325, UE 115-b may select a PRB bundling size based on the determined one or more parameters. In such cases, the selected PRB bundling size may be based on channel characteristics (as opposed to a predefined PRB bundling size) identified using the one or more parameters. In addition, the use of a UE-selected PRB bundling size may enhance the selection of DMRS configurations for enhancing spectral efficiency and channel estimation accuracy.

At 330, UE 115-b may transmit, to base station 105-b, a report including an indication of the selected PRB bundling size. In some examples, the report may be a CSF report that may include CQI, PMI, RI, or any combination thereof. In some aspects, the CSF report may include the indication of the PRB bundling size as well as other values (e.g., CQI, PMI, RI) that may be evaluated by UE 115-b based at least in part on an assumption of the reported PRB bundling size assumed for one or more CSI reference resources.

In some examples, a format of the report from UE 115-b may exclude some types of CQI report formats. For example, the format of the report may not include a feedback report that includes a combination of a CSI resource indicator (CRI), RI, i1, and CQI (e.g., a “cri-RI-i1-CQI” report) and assumes a random i2 precoding selection (per PRG) and may have a dedicated PRG size configuration for a corresponding CSI report ID. However, the report may be of another format supported by the system, and may enable the transmission of the PRB bundle size recommended by UE 115-b (e.g., via two bits of the report). In some cases, the report may also include an indication of a DMRS configuration or a DMRS configuration change request bit.

At 335, base station 105-b may determine CSI reference resource assumptions for the PRB bundling size. For example, a PRB bundling size assumption of a CSI reference resource associated with a CSF procedure may be based on the indication, or report, or both, of the PRB bundling size from UE 115-b. In some cases, the report from UE 115-b may be a CSF report that is transmitted periodically, aperiodically (e.g., based on a trigger from base station 105-b), or semi-persistently.

At 440, base station 105-b may determine a PRG size for one or more PDSCH transmissions to UE 115-b, which may be based on the PRG bundling size recommended by UE 115-b (e.g., included in the report). In some examples, base station 105-b may precode one or more allocated resources in accordance with the indicated PRB bundling size.

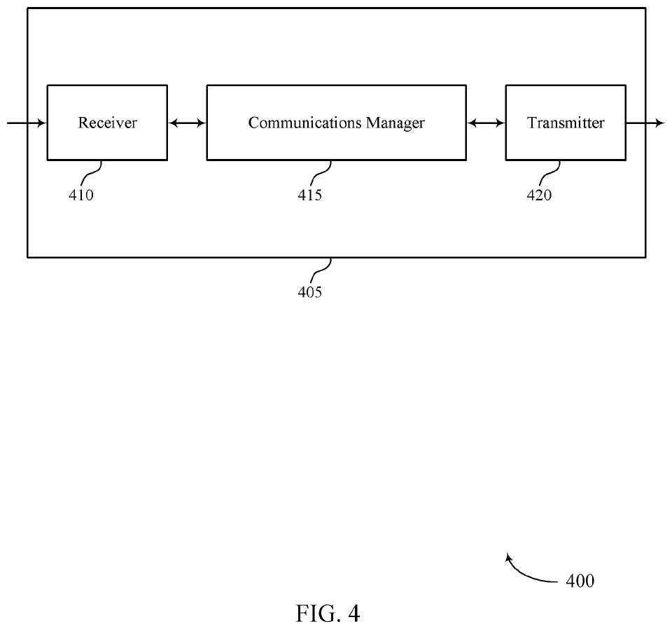

FIG. 4 shows a block diagram 400 of a device 405 that supports physical resource block bundling size recommendation reporting in accordance with aspects of the present disclosure. The device 405 may be an example of aspects of a UE 115 as described herein. The device 405 may include a receiver 410, a communications manager 415, and a transmitter 420. The device 405 may also include a processor. Each of these components may be in communication with one another (e.g., via one or more buses).

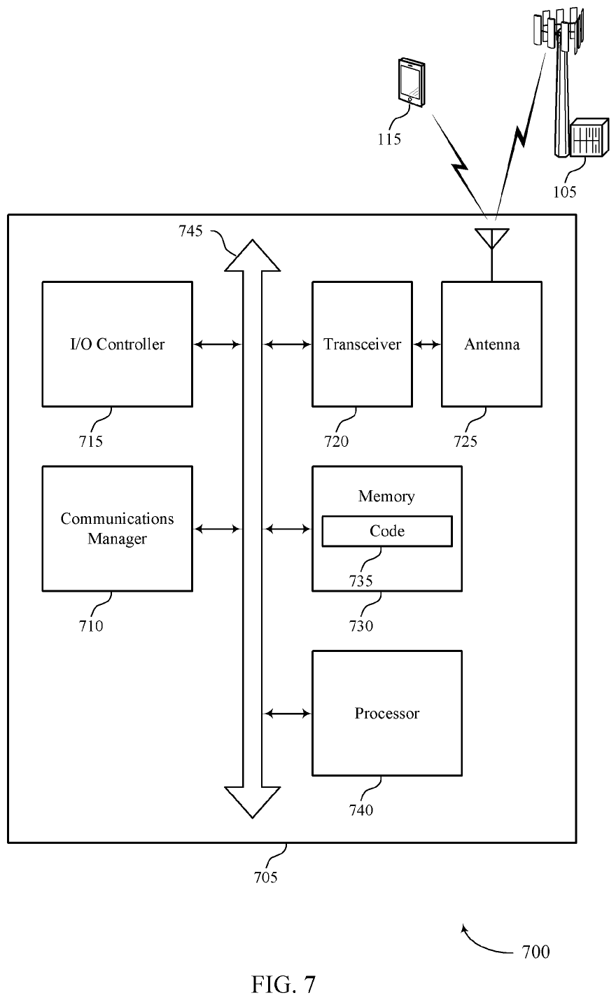

The receiver 410 may receive information such as packets, user data, or control information associated with various information channels (e.g., control channels, data channels, and information related to physical resource block bundling size recommendation reporting, etc.). Information may be passed on to other components of the device 405. The receiver 410 may be an example of aspects of the transceiver 720 described with reference to FIG. 7. The receiver 410 may utilize a single antenna or a set of antennas.

The communications manager 415 may determine one or more parameters that indicate channel characteristics of a channel for communicating with a base station. The communications manager 415 may select a physical resource block bundling size based on the determined one or more parameters. The communications manager 415 may transmit, to the base station, a report including an indication of the selected physical resource block bundling size. The communications manager 415 may be an example of aspects of the communications manager 710 described herein.

The communications manager 415, or its sub-components, may be implemented in hardware, code (e.g., software or firmware) executed by a processor, or any combination thereof. If implemented in code executed by a processor, the functions of the communications manager 415, or its sub-components may be executed by a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described in the present disclosure.

The communications manager 415, or its sub-components, may be physically located at various positions, including being distributed such that portions of functions are implemented at different physical locations by one or more physical components. In some examples, the communications manager 415, or its sub-components, may be a separate and distinct component in accordance with various aspects of the present disclosure. In some examples, the communications manager 415, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 420 may transmit signals generated by other components of the device 405. In some examples, the transmitter 420 may be collocated with a receiver 410 in a transceiver module. For example, the transmitter 420 may be an example of aspects of the transceiver 720 described with reference to FIG. 7. The transmitter 420 may utilize a single antenna or a set of antennas.

In some examples, the communications manager 415 may be implemented as an integrated circuit or chipset for a mobile device modem, and the receiver 410 and transmitter 420 may be implemented as analog components (e.g., amplifiers, filters, antennas) coupled with the mobile device modem to enable wireless transmission and reception over one or more bands.

The communications manager 415 as described herein may be implemented to realize one or more potential advantages. One implementation may allow the device 405 to provide assistance for determining a less restrictive PRB bundling size configuration between the device 405 and a base station. Based on the techniques for reporting PRB bundling size, the device 405 may perform more accurate channel estimation during PDSCH reception, may provide more accurate CSF reporting and also inform more accurate DMRS configuration.

As such, the device 405 may increase the likelihood of accurate channel estimation during PDSCH reception and, accordingly, may communicate over the channel with reduced reference signal overhead and higher spectral efficiency. In some examples, based on reduced reference signal overhead and higher spectral efficiency, the device 405 may operate relatively more efficiently, which may enable the device to save power and increase battery life.

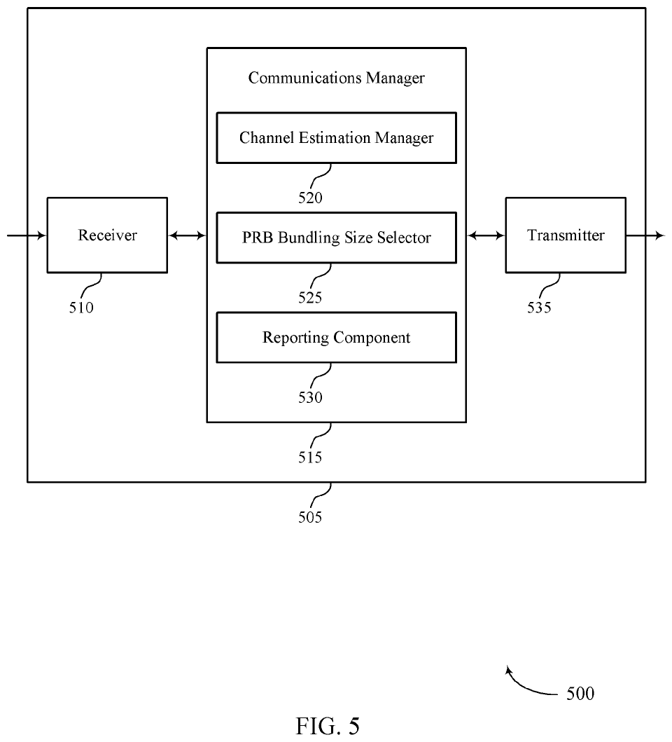

FIG. 5 shows a block diagram 500 of a device 505 that supports physical resource block bundling size recommendation reporting in accordance with aspects of the present disclosure. The device 505 may be an example of aspects of a device 405, or a UE 115 as described herein. The device 505 may include a receiver 510, a communications manager 515, and a transmitter 535. The device 505 may also include a processor. Each of these components may be in communication with one another (e.g., via one or more buses).

The receiver 510 may receive information such as packets, user data, or control information associated with various information channels (e.g., control channels, data channels, and information related to physical resource block bundling size recommendation reporting, etc.). Information may be passed on to other components of the device 505. The receiver 510 may be an example of aspects of the transceiver 720 described with reference to FIG. 7. The receiver 510 may utilize a single antenna or a set of antennas.

The communications manager 515 may be an example of aspects of the communications manager 415 as described herein. The communications manager 515 may include a channel estimation manager 520, a PRB bundling size selector 525, and a reporting component 530. The communications manager 515 may be an example of aspects of the communications manager 710 described herein.

The channel estimation manager 520 may determine one or more parameters that indicate channel characteristics of a channel for communicating with a base station.

The PRB bundling size selector 525 may select a physical resource block bundling size based on the determined one or more parameters.

The reporting component 530 may transmit, to the base station, a report including an indication of the selected physical resource block bundling size.

The transmitter 535 may transmit signals generated by other components of the device 505. In some examples, the transmitter 535 may be collocated with a receiver 510 in a transceiver module. For example, the transmitter 535 may be an example of aspects of the transceiver 720 described with reference to FIG. 7. The transmitter 535 may utilize a single antenna or a set of antennas.

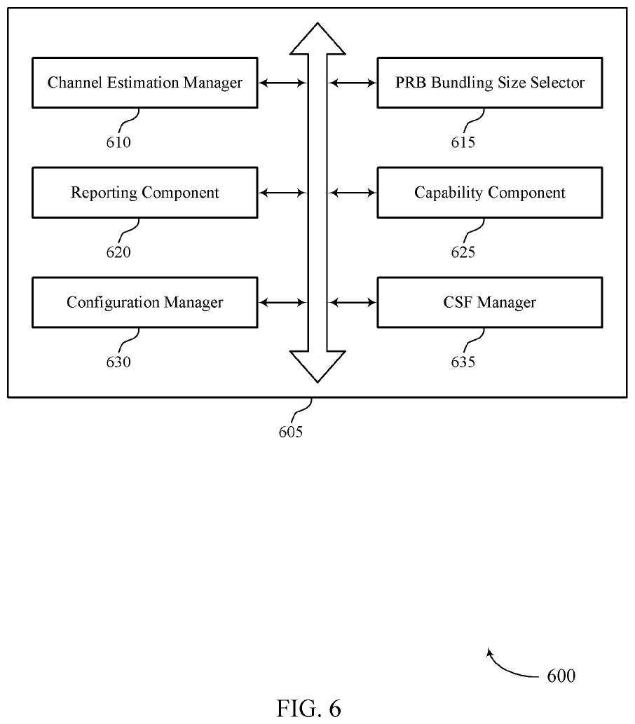

FIG. 6 shows a block diagram 600 of a communications manager 605 that supports physical resource block bundling size recommendation reporting in accordance with aspects of the present disclosure. The communications manager 605 may be an example of aspects of a communications manager 415, a communications manager 515, or a communications manager 710 described herein. The communications manager 605 may include a channel estimation manager 610, a PRB bundling size selector 615, a reporting component 620, a capability component 625, a configuration manager 630, and a CSF manager 635. Each of these modules may communicate, directly or indirectly, with one another (e.g., via one or more buses).

The channel estimation manager 610 may determine one or more parameters that indicate channel characteristics of a channel for communicating with a base station. In some cases, the one or more parameters include a delay spread of the channel, an input SINR, a post-processing SINR, a channel estimation error floor, one or more precoding values, a precoding variability, one or more subbands, or any combination thereof.

The PRB bundling size selector 615 may select a physical resource block bundling size based on the determined one or more parameters. In some examples, the PRB bundling size selector 615 may select the physical resource block bundling size from a set of physical resource block bundling sizes including at least a two resource block physical resource block bundling size, or a four resource block physical resource block bundling size, and a wideband physical resource block bundling size. In some cases, the selected physical resource block bundling size includes the wideband PRB bundling size, the wideband PRB bundling size corresponding to the subband size associated with the report. In such cases, the wideband PRB bundling size indication, if reported, may be interpreted as matching the configured subband size corresponding to the report.

The reporting component 620 may transmit, to the base station, a report including an indication of the selected physical resource block bundling size.

In some examples, the reporting component 620 may transmit the report periodically, aperiodically, or semi-persistently. In some cases, a format of the report excludes a CSI report format that assumes a random precoding for report determination and has a corresponding preconfigured precoding resource block group size for report evaluation.

In some cases, the indication of the selected physical resource block bundling size includes two or more bits of the report. In some cases, the report includes a CSF report that includes a CQI, a PMI, a RI, or any combination thereof. In some cases, the CSF report includes an indication of a DMRS configuration or a DMRS configuration change request (e.g., indicated with one or more bits).

The capability component 625 may transmit an indication of a UE capability for indicating the physical resource block bundling size, where selecting the physical resource block bundling size is based on the UE capability.

The configuration manager 630 may receive, from the base station, a configuration of the report based on the indication of the UE capability, where transmitting the report including the indication of the selected physical resource block bundling size is based on the configuration.

In some examples, the configuration manager 630 may receive RRC signaling including an information element that configures the report.

In some examples, the configuration manager 630 may receive a MAC-CE that configures the report.

The CSF manager 635 may determine or use, as part of an evaluation of the channel state feedback report, an assumption of a bundling size for a reference resource, wherein the assumption corresponds to the bundling size being the same as the selected physical resource block bundling size indicated by the report. In such cases, the CSF manager 635 may use a PRB bundling size assumption for a CSI reference resource, where the assumed PRB bundling size of the CSI reference resource may be the same as the PRB bundling size recommended in the report (e.g., reported in the same report). In some examples, the report includes a CSF report associated with a first CSI report ID, the CSF report being configured to include the indication of the selected PRB bundling size. That is, a CSF report for a CSI report ID may be configured to include a PRB bundling size recommendation.

In some examples, the CSF manager 635 may identify a configuration of a second report associated with a second CSI report ID, the second report being configured to exclude the indication of the selected physical resource block bundling size based on a capability of the UE. In some examples, the second CSI report ID may be associated with a default assumption of a predetermined PRB bundling size (e.g., 2 PRBs) if the corresponding report is not configured to include a PRB bundling size recommendation. In some examples, the CSF manager 635 may determine or use, as part of an evaluation of the second report, an assumption of a predetermined bundling size for a second reference resource.

In some examples, the CSF manager 635 may identify that the report is configured to include the indication of the selected PRB bundling size and further configured for subband CSF reporting for at least one of a CQI, a PMI, or a DMRS configuration. In some examples, the CSF manager 635 may determine or assume a subband size based on the configuration. That is, the subband size may be assumed when evaluating the report based on the report being configured for per-subband reporting.

In some examples, the CSF manager 635 may transmit, as part of the report, an indication of the channel quality indicator, the PMI, the DMRS configuration, or any combination thereof, based on the subband size and the configuration. As described herein, the report may further include the selected PRB bundling size.

FIG. 7 shows a diagram of a system 700 including a device 705 that supports physical resource block bundling size recommendation reporting in accordance with aspects of the present disclosure. The device 705 may be an example of or include the components of device 405, device 505, or a UE 115 as described herein. The device 705 may include components for bi-directional voice and data communications including components for transmitting and receiving communications, including a communications manager 710, an I/O controller 715, a transceiver 720, an antenna 725, memory 730, and a processor 740. These components may be in electronic communication via one or more buses (e.g., bus 745).

The communications manager 710 may determine one or more parameters that indicate channel characteristics of a channel for communicating with a base station, select a physical resource block bundling size based on the determined one or more parameters, and transmit, to the base station, a report including an indication of the selected physical resource block bundling size.

The I/O controller 715 may manage input and output signals for the device 705. The I/O controller 715 may also manage peripherals not integrated into the device 705. In some cases, the I/O controller 715 may represent a physical connection or port to an external peripheral. In some cases, the I/O controller 715 may utilize an operating system such as iOS®, ANDROID®, MS-DOS®, MS-WINDOWS®, OS/2®, UNIX®, LINUX®, or another known operating system. In other cases, the I/O controller 715 may represent or interact with a modem, a keyboard, a mouse, a touchscreen, or a similar device. In some cases, the I/O controller 715 may be implemented as part of a processor. In some cases, a user may interact with the device 705 via the I/O controller 715 or via hardware components controlled by the I/O controller 715.

The transceiver 720 may communicate bi-directionally, via one or more antennas, wired, or wireless links as described herein. For example, the transceiver 720 may represent a wireless transceiver and may communicate bi-directionally with another wireless transceiver. The transceiver 720 may also include a modem to modulate the packets and provide the modulated packets to the antennas for transmission, and to demodulate packets received from the antennas.

In some cases, the wireless device may include a single antenna 725. However, in some cases the device may have more than one antenna 725, which may be capable of concurrently transmitting or receiving multiple wireless transmissions.

The memory 730 may include random access memory (RAM) and read-only memory (ROM). The memory 730 may store computer-readable, computer-executable code 735 including instructions that, when executed, cause the processor to perform various functions described herein. In some cases, the memory 730 may contain, among other things, a basic input/output system (BIOS) which may control basic hardware or software operation such as the interaction with peripheral components or devices.

The processor 740 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 740 may be configured to operate a memory array using a memory controller. In other cases, a memory controller may be integrated into the processor 740. The processor 740 may be configured to execute computer-readable instructions stored in a memory (e.g., the memory 730) to cause the device 705 to perform various functions (e.g., functions or tasks supporting physical resource block bundling size recommendation reporting).

The code 735 may include instructions to implement aspects of the present disclosure, including instructions to support wireless communications. The code 735 may be stored in a non-transitory computer-readable medium such as system memory or other type of memory. In some cases, the code 735 may not be directly executable by the processor 740 but may cause a computer (e.g., when compiled and executed) to perform functions described herein.

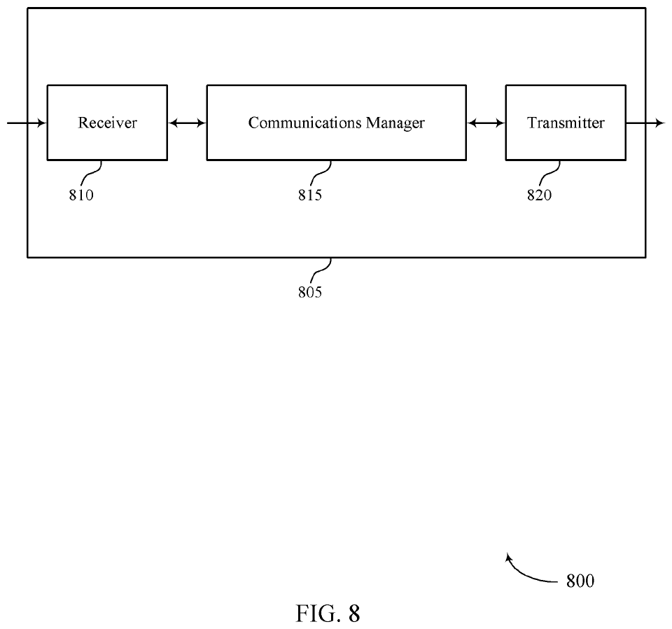

FIG. 8 shows a block diagram 800 of a device 805 that supports physical resource block bundling size recommendation reporting in accordance with aspects of the present disclosure. The device 805 may be an example of aspects of a base station 105 as described herein. The device 805 may include a receiver 810, a communications manager 815, and a transmitter 820. The device 805 may also include a processor. Each of these components may be in communication with one another (e.g., via one or more buses).

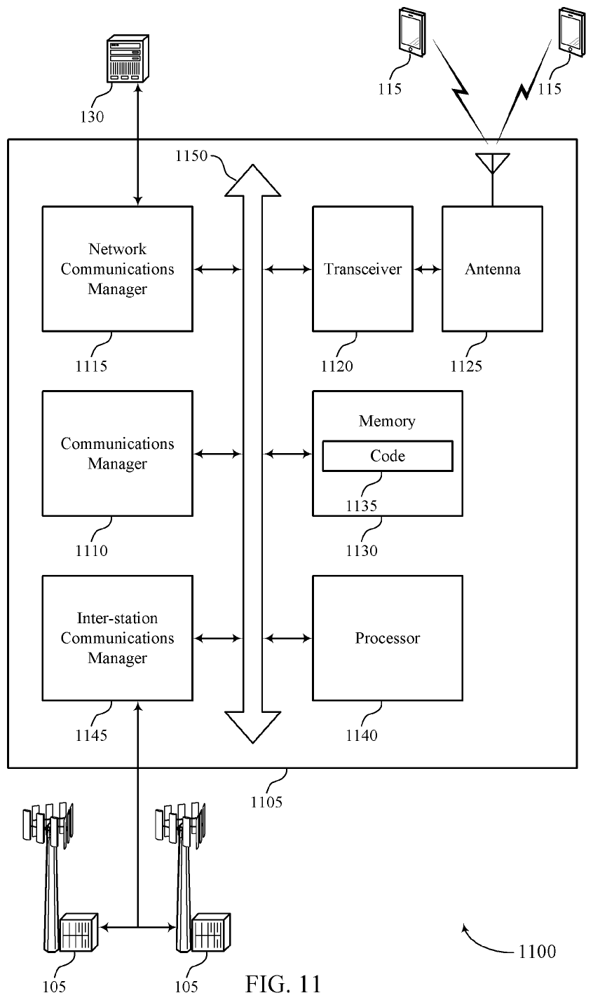

The receiver 810 may receive information such as packets, user data, or control information associated with various information channels (e.g., control channels, data channels, and information related to physical resource block bundling size recommendation reporting, etc.). Information may be passed on to other components of the device 805. The receiver 810 may be an example of aspects of the transceiver 1120 described with reference to FIG. 11. The receiver 810 may utilize a single antenna or a set of antennas.

The communications manager 815 may receive, from a UE, a report including an indication of a physical resource block bundling size. The communications manager 815 may determine a bundling size assumption for a reference resource associated with a CSF procedure based on the indication of the physical resource block bundling size. The communications manager 815 may be an example of aspects of the communications manager 1110 described herein.

The communications manager 815, or its sub-components, may be implemented in hardware, code (e.g., software or firmware) executed by a processor, or any combination thereof. If implemented in code executed by a processor, the functions of the communications manager 815, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 815, or its sub-components, may be physically located at various positions, including being distributed such that portions of functions are implemented at different physical locations by one or more physical components. In some examples, the communications manager 815, or its sub-components, may be a separate and distinct component in accordance with various aspects of the present disclosure. In some examples, the communications manager 815, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 820 may transmit signals generated by other components of the device 805. In some examples, the transmitter 820 may be collocated with a receiver 810 in a transceiver module. For example, the transmitter 820 may be an example of aspects of the transceiver 1120 described with reference to FIG. 11. The transmitter 820 may utilize a single antenna or a set of antennas.

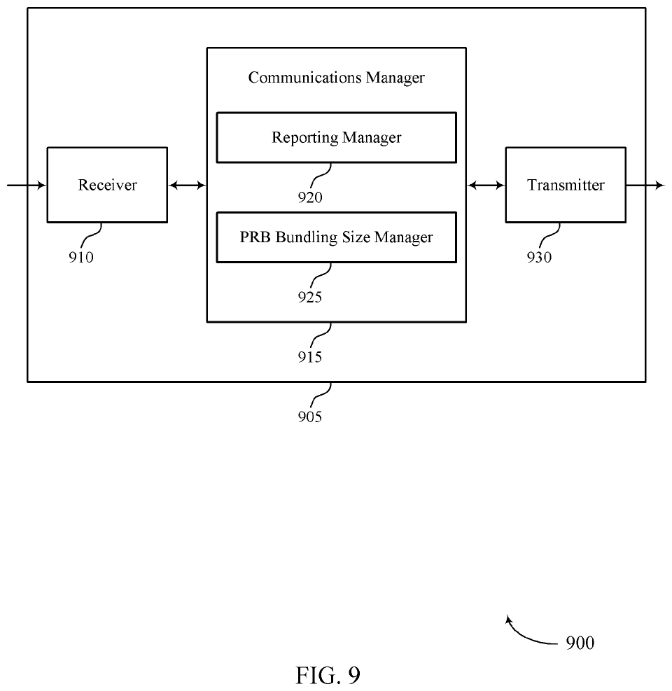

FIG. 9 shows a block diagram 900 of a device 905 that supports physical resource block bundling size recommendation reporting in accordance with aspects of the present disclosure. The device 905 may be an example of aspects of a device 805, or a base station 105 as described herein. The device 905 may include a receiver 910, a communications manager 915, and a transmitter 930. The device 905 may also include a processor. Each of these components may be in communication with one another (e.g., via one or more buses).

The receiver 910 may receive information such as packets, user data, or control information associated with various information channels (e.g., control channels, data channels, and information related to physical resource block bundling size recommendation reporting, etc.). Information may be passed on to other components of the device 905. The receiver 910 may be an example of aspects of the transceiver 1120 described with reference to FIG. 11. The receiver 910 may utilize a single antenna or a set of antennas.

The communications manager 915 may be an example of aspects of the communications manager 815 as described herein. The communications manager 915 may include a reporting manager 920 and a PRB bundling size manager 925. The communications manager 915 may be an example of aspects of the communications manager 1110 described herein.

The reporting manager 920 may receive, from a UE, a report including an indication of a physical resource block bundling size.

The PRB bundling size manager 925 may determine a bundling size assumption for a reference resource associated with a CSF procedure based on the indication of the physical resource block bundling size.

The transmitter 930 may transmit signals generated by other components of the device 905. In some examples, the transmitter 930 may be collocated with a receiver 910 in a transceiver module. For example, the transmitter 930 may be an example of aspects of the transceiver 1120 described with reference to FIG. 11. The transmitter 930 may utilize a single antenna or a set of antennas.

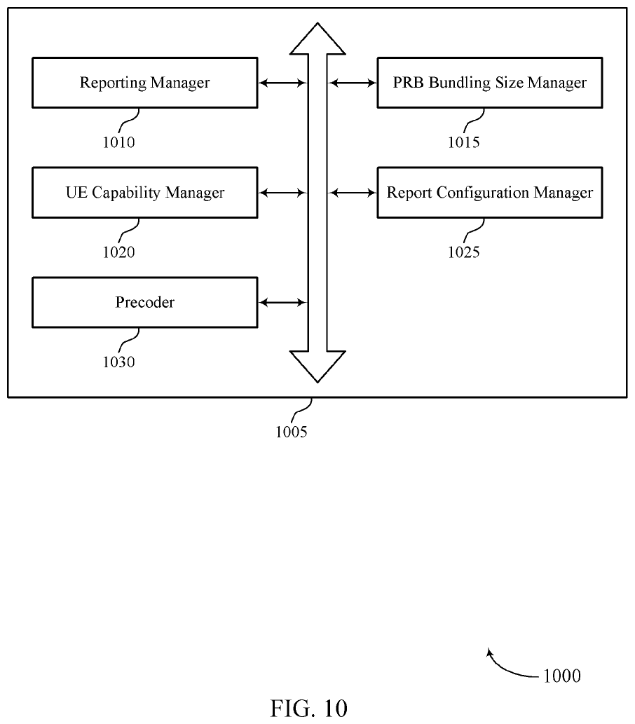

FIG. 10 shows a block diagram 1000 of a communications manager 1005 that supports physical resource block bundling size recommendation reporting in accordance with aspects of the present disclosure. The communications manager 1005 may be an example of aspects of a communications manager 815, a communications manager 915, or a communications manager 1110 described herein. The communications manager 1005 may include a reporting manager 1010, a PRB bundling size manager 1015, a UE capability manager 1020, a report configuration manager 1025, and a precoder 1030. Each of these modules may communicate, directly or indirectly, with one another (e.g., via one or more buses).

The reporting manager 1010 may receive, from a UE, a report including an indication of a physical resource block bundling size. In some examples, the reporting manager 1010 may receive, as part of the report, an indication of a CQI, a PMI, a DMRS configuration, or any combination thereof, based on a configured subband size associated with the report (e.g., for subband CSF reporting).

In some examples, the reporting manager 1010 may receive the report periodically, aperiodically, or semi-persistently. In some cases, a format of the report excludes a CSI report format that assumes a random precoding for report determination and has a corresponding preconfigured precoding resource block group size for report evaluation. In some cases, the indication of the physical resource block bundling size includes two or more bits of the report.

In some cases, the report is a CSF report that includes a channel quality indicator, a PMI, a RI, or any combination thereof. In some cases, the CSF report includes an indication of a DMRS configuration or a DMRS configuration change request bit.

The PRB bundling size manager 1015 may determine a bundling size assumption for a reference resource associated with a CSF procedure based on the indication of the physical resource block bundling size. In some cases, the indicated physical resource block bundling size includes a wideband physical resource block bundling size, and the wideband physical resource block bundling size may be interpreted as matching the configured subband size associated with the report. That is, the wideband physical resource block bundling size indication, if reported, may be interpreted as matching the corresponding subband size (e.g., configured for the report).

In some cases, the physical resource block bundling size is from a set of physical resource block bundling sizes including at least a two resource block physical resource block bundling size, or a four resource block physical resource block bundling size, and a wideband physical resource block bundling size. In some cases, the physical resource block bundling size is based on one or more parameters including a delay spread of the channel, an input SINR, a post-processing SINR, a channel estimation error floor, one or more precoding values, a precoding variability, one or more subbands, or any combination thereof.

The UE capability manager 1020 may receive, from the UE, an indication of a UE capability for indicating the physical resource block bundling size.

The report configuration manager 1025 may transmit, to the UE, a configuration of the report based on the indication of the UE capability, where receiving the report including the indication of the selected physical resource block bundling size is based on the configuration. In some examples, the report configuration manager 1025 may transmit, to the UE, a configuration of a second report associated with a CSI report ID, the second report configured to exclude the indication of the physical resource block bundling size based on the indication of the UE capability.

In some examples, the report configuration manager 1025 may transmit RRC signaling including an information element that configures the report. In some examples, the report configuration manager 1025 may transmit a MAC-CE that configures the report.

The precoder 1030 may precode one or more allocated resources in accordance with the indicated physical resource block bundling size, where the report includes a CSF report associated with a CSI report ID having a configuration for physical resource block bundling size reporting.

FIG. 11 shows a diagram of a system 1100 including a device 1105 that supports physical resource block bundling size recommendation reporting in accordance with aspects of the present disclosure. The device 1105 may be an example of or include the components of device 805, device 905, or a base station 105 as described herein. The device 1105 may include components for bi-directional voice and data communications including components for transmitting and receiving communications, including a communications manager 1110, a network communications manager 1115, a transceiver 1120, an antenna 1125, memory 1130, a processor 1140, and an inter-station communications manager 1145. These components may be in electronic communication via one or more buses (e.g., bus 1150).

The communications manager 1110 may receive, from a UE, a report including an indication of a physical resource block bundling size and determine a bundling size assumption for a reference resource associated with a CSF procedure based on the indication of the physical resource block bundling size.

The network communications manager 1115 may manage communications with the core network (e.g., via one or more wired backhaul links). For example, the network communications manager 1115 may manage the transfer of data communications for client devices, such as one or more UEs 115.

The transceiver 1120 may communicate bi-directionally, via one or more antennas, wired, or wireless links as described herein. For example, the transceiver 1120 may represent a wireless transceiver and may communicate bi-directionally with another wireless transceiver. The transceiver 1120 may also include a modem to modulate the packets and provide the modulated packets to the antennas for transmission, and to demodulate packets received from the antennas.

In some cases, the wireless device may include a single antenna 1125. However, in some cases the device may have more than one antenna 1125, which may be capable of concurrently transmitting or receiving multiple wireless transmissions.

The memory 1130 may include RAM, ROM, or a combination thereof. The memory 1130 may store computer-readable code 1135 including instructions that, when executed by a processor (e.g., the processor 1140) cause the device to perform various functions described herein. In some cases, the memory 1130 may contain, among other things, a BIOS which may control basic hardware or software operation such as the interaction with peripheral components or devices.

The processor 1140 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some cases, a memory controller may be integrated into processor 1140. The processor 1140 may be configured to execute computer-readable instructions stored in a memory (e.g., the memory 1130) to cause the device 1105 to perform various functions (e.g., functions or tasks supporting physical resource block bundling size recommendation reporting).

The inter-station communications manager 1145 may manage communications with other base station 105, and may include a controller or scheduler for controlling communications with UEs 115 in cooperation with other base stations 105. For example, the inter-station communications manager 1145 may coordinate scheduling for transmissions to UEs 115 for various interference mitigation techniques such as beamforming or joint transmission. In some examples, the inter-station communications manager 1145 may provide an X2 interface within an LTE/LTE-A wireless communication network technology to provide communication between base stations 105.

The code 1135 may include instructions to implement aspects of the present disclosure, including instructions to support wireless communications. The code 1135 may be stored in a non-transitory computer-readable medium such as system memory or other type of memory. In some cases, the code 1135 may not be directly executable by the processor 1140 but may cause a computer (e.g., when compiled and executed) to perform functions described herein.

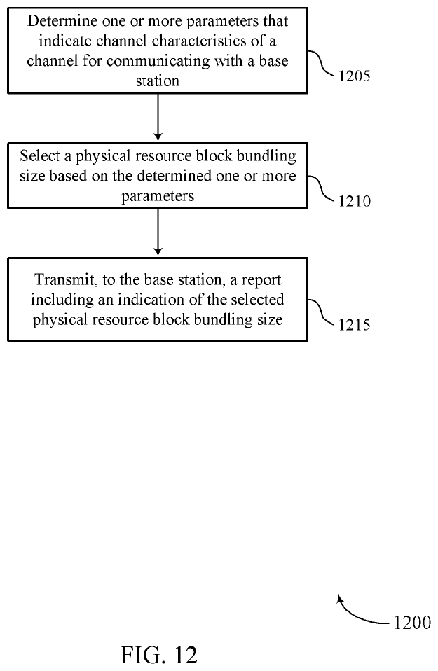

FIG. 12 shows a flowchart illustrating a method 1200 that supports physical resource block bundling size recommendation reporting in accordance with aspects of the present disclosure. The operations of method 1200 may be implemented by a UE 115 or its components as described herein. For example, the operations of method 1200 may be performed by a communications manager as described with reference to FIGS. 4 through 7. In some examples, a UE may execute a set of instructions to control the functional elements of the UE to perform the functions described herein. Additionally or alternatively, a UE may perform aspects of the functions described herein using special-purpose hardware.

At 1205, the UE may determine one or more parameters that indicate channel characteristics of a channel for communicating with a base station. The operations of 1205 may be performed according to the methods described herein. In some examples, aspects of the operations of 1205 may be performed by a channel estimation manager as described with reference to FIGS. 4 through 7.

At 1210, the UE may select a physical resource block bundling size based on the determined one or more parameters. The operations of 1210 may be performed according to the methods described herein. In some examples, aspects of the operations of 1210 may be performed by a PRB bundling size selector as described with reference to FIGS. 4 through 7.

At 1215, the UE may transmit, to the base station, a report including an indication of the selected physical resource block bundling size. The operations of 1215 may be performed according to the methods described herein. In some examples, aspects of the operations of 1215 may be performed by a reporting component as described with reference to FIGS. 4 through 7.

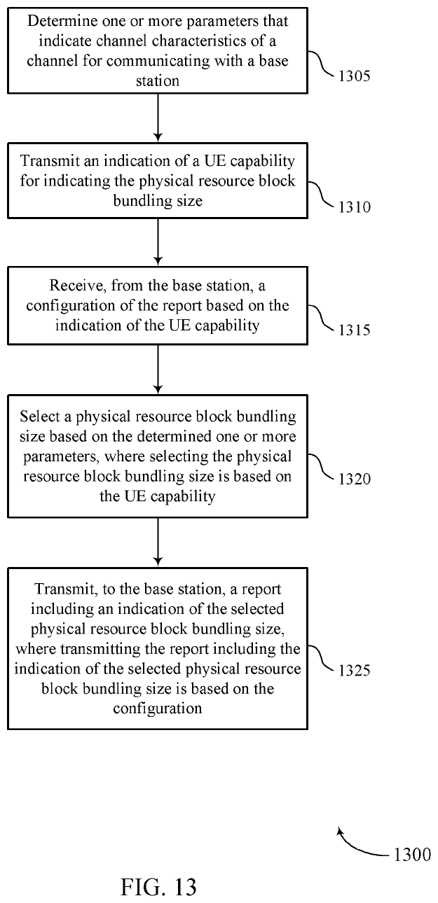

FIG. 13 shows a flowchart illustrating a method 1300 that supports physical resource block bundling size recommendation reporting in accordance with aspects of the present disclosure. The operations of method 1300 may be implemented by a UE 115 or its components as described herein. For example, the operations of method 1300 may be performed by a communications manager as described with reference to FIGS. 4 through 7. In some examples, a UE may execute a set of instructions to control the functional elements of the UE to perform the functions described herein. Additionally or alternatively, a UE may perform aspects of the functions described herein using special-purpose hardware.

At 1305, the UE may determine one or more parameters that indicate channel characteristics of a channel for communicating with a base station. The operations of 1305 may be performed according to the methods described herein. In some examples, aspects of the operations of 1305 may be performed by a channel estimation manager as described with reference to FIGS. 4 through 7.

At 1310, the UE may transmit an indication of a UE capability for indicating the physical resource block bundling size, where selecting the physical resource block bundling size is based on the UE capability. The operations of 1310 may be performed according to the methods described herein. In some examples, aspects of the operations of 1310 may be performed by a capability component as described with reference to FIGS. 4 through 7.

At 1315, the UE may receive, from the base station, a configuration of the report based on the indication of the UE capability, where transmitting the report including the indication of the selected physical resource block bundling size is based on the configuration. The operations of 1315 may be performed according to the methods described herein. In some examples, aspects of the operations of 1315 may be performed by a configuration manager as described with reference to FIGS. 4 through 7.

At 1320, the UE may select a physical resource block bundling size based on the determined one or more parameters. The operations of 1320 may be performed according to the methods described herein. In some examples, aspects of the operations of 1320 may be performed by a PRB bundling size selector as described with reference to FIGS. 4 through 7.

At 1325, the UE may transmit, to the base station, a report including an indication of the selected physical resource block bundling size. The operations of 1325 may be performed according to the methods described herein. In some examples, aspects of the operations of 1325 may be performed by a reporting component as described with reference to FIGS. 4 through 7.

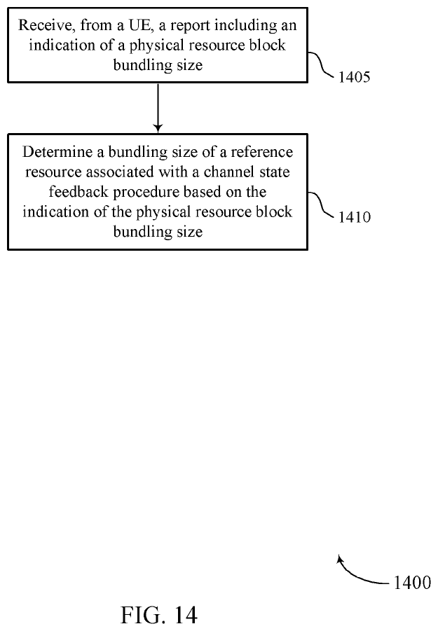

FIG. 14 shows a flowchart illustrating a method 1400 that supports physical resource block bundling size recommendation reporting in accordance with aspects of the present disclosure. The operations of method 1400 may be implemented by a base station 105 or its components as described herein. For example, the operations of method 1400 may be performed by a communications manager as described with reference to FIGS. 8 through 11. In some examples, a base station may execute a set of instructions to control the functional elements of the base station to perform the functions described herein. Additionally or alternatively, a base station may perform aspects of the functions described herein using special-purpose hardware.

At 1405, the base station may receive, from a UE, a report including an indication of a physical resource block bundling size. The operations of 1405 may be performed according to the methods described herein. In some examples, aspects of the operations of 1405 may be performed by a reporting manager as described with reference to FIGS. 8 through 11.

At 1410, the base station may determine a bundling size assumption for a reference resource associated with a CSF procedure based on the indication of the physical resource block bundling size. The operations of 1410 may be performed according to the methods described herein. In some examples, aspects of the operations of 1410 may be performed by a PRB bundling size manager as described with reference to FIGS. 8 through 11.

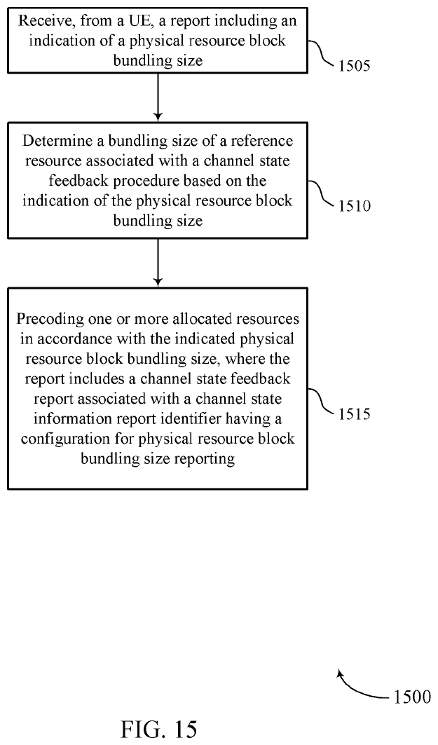

FIG. 15 shows a flowchart illustrating a method 1500 that supports physical resource block bundling size recommendation reporting in accordance with aspects of the present disclosure. The operations of method 1500 may be implemented by a base station 105 or its components as described herein. For example, the operations of method 1500 may be performed by a communications manager as described with reference to FIGS. 8 through 11. In some examples, a base station may execute a set of instructions to control the functional elements of the base station to perform the functions described herein. Additionally or alternatively, a base station may perform aspects of the functions described herein using special-purpose hardware.

At 1505, the base station may receive, from a UE, a report including an indication of a physical resource block bundling size. The operations of 1505 may be performed according to the methods described herein. In some examples, aspects of the operations of 1505 may be performed by a reporting manager as described with reference to FIGS. 8 through 11.

At 1510, the base station may determine a bundling size assumption for a reference resource associated with a CSF procedure based on the indication of the physical resource block bundling size. The operations of 1510 may be performed according to the methods described herein. In some examples, aspects of the operations of 1510 may be performed by a PRB bundling size manager as described with reference to FIGS. 8 through 11.

At 1515, the base station may precode one or more allocated resources in accordance with the indicated physical resource block bundling size, where the report includes a CSF report associated with a CSI report ID having a configuration for physical resource block bundling size reporting. The operations of 1515 may be performed according to the methods described herein. In some examples, aspects of the operations of 1515 may be performed by a precoder as described with reference to FIGS. 8 through 11.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A method for wireless communication at a user equipment (UE), comprising:
determining one or more parameters that indicate channel characteristics of a channel for communicating with a network device;
selecting a physical resource block bundling size based at least in part on the determined one or more parameters; and
transmitting, to the network device, a report including an indication of the selected physical resource block bundling size.

2. The method of claim 1, further comprising:
transmitting an indication of a UE capability for indicating the physical resource block bundling size, wherein selecting the physical resource block bundling size is based at least in part on the UE capability.

3. The method of claim 2, further comprising:
receiving, from the network device, a configuration of the report based at least in part on the indication of the UE capability, wherein transmitting the report including the indication of the selected physical resource block bundling size is based at least in part on the configuration.

4. The method of claim 3, wherein receiving the configuration comprises:
receiving radio resource control signaling including an information element that configures the report.

5. The method of claim 3, wherein receiving the configuration comprises:
receiving a medium access control (MVAC) control element that configures the report.

6. The method of claim 1, wherein the report comprises a channel state feedback report associated with a first channel state information report identifier, the channel state feedback report being configured to include the indication of the selected physical resource block bundling size, the method further comprising:
using, as part of an evaluation of the channel state feedback report, an assumption of a bundling size for a reference resource, wherein the assumption corresponds to the bundling size being a same size as the selected physical resource block bundling size indicated by the report.

7. The method of claim 6, further comprising:
identifying a configuration of a second report associated with a second channel state information report identifier, the second report being configured to exclude the indication of the selected physical resource block bundling size based at least in part on a capability of the UE; and
using, as part of an evaluation of the second report, an assumption of a predetermined bundling size for a second reference resource.

8. The method of claim 1, further comprising:
identifying that the report is configured to include the indication of the selected physical resource block bundling size and further configured for subband channel state feedback reporting for at least one of a channel quality indicator, a precoding matrix indicator, or a demodulation reference signal configuration;
determining a subband size associated with the report based at least in part on the configuration; and
transmitting, as part of the report, an indication of the channel quality indicator, the precoding matrix indicator, the demodulation reference signal configuration, or any combination thereof, based at least in part on the subband size and the configuration.

9. The method of claim 8, wherein the selected physical resource block bundling size comprises a wideband physical resource block bundling size, the wideband physical resource block bundling size corresponding to the subband size associated with the report based at least in part on the configuration.

10. The method of claim 1, wherein a format of the report excludes a channel state information report format that assumes a random precoding for report determination and has a corresponding preconfigured precoding resource block group size for report evaluation.

11. The method of claim 1, wherein the indication of the selected physical resource block bundling size comprises two or more bits of the report.

12. The method of claim 1, wherein transmitting the report comprises:
transmitting the report periodically, aperiodically, or semi-persistently.

13. The method of claim 1, wherein selecting the physical resource block bundling size comprises:
selecting the physical resource block bundling size from a set of physical resource block bundling sizes including at least a two resource block physical resource block bundling size, or a four resource block physical resource block bundling size, and a wideband physical resource block bundling size.

14. The method of claim 1, wherein the one or more parameters comprise a delay spread of the channel, an input signal-to-interference plus noise ratio, a post-processing signal-to-interference plus noise ratio, a channel estimation error floor, one or more precoding values, a precoding variability, one or more subbands, or any combination thereof.

15. The method of claim 1, wherein the report comprises a channel state feedback report comprising a channel quality indicator, a precoding matrix indicator, a rank indicator, or any combination thereof.

16. The method of claim 15, wherein the channel state feedback report includes an indication of a demodulation reference signal configuration or a demodulation reference signal configuration change request.

17. A method for wireless communication at a network device, comprising:
receiving, from a user equipment (UE), a report including an indication of a physical resource block bundling size; and
determining a bundling size of a reference resource associated with a channel state feedback procedure based at least in part on the indication of the physical resource block bundling size.

18. The method of claim 17, further comprising:
receiving, from the UE, an indication of a UE capability for indicating the physical resource block bundling size; and
transmitting, to the UE, a configuration of the report based at least in part on the indication of the UE capability, wherein receiving the report including the indication of the physical resource block bundling size is based at least in part on the configuration.

19. The method of claim 18, further comprising:
transmitting, to the UE, a configuration of a second report associated with a channel state information report identifier, the second report configured to exclude the indication of the physical resource block bundling size based at least in part on the indication of the UE capability.

20. The method of claim 18, wherein transmitting the configuration comprises:
transmitting radio resource control signaling including an information element that configures the report.

21. The method of claim 18, wherein transmitting the configuration comprises:
transmitting a medium access control (MVAC) control element that configures the report.

22. The method of claim 17, further comprising:
precoding one or more allocated resources in accordance with the indicated physical resource block bundling size, wherein the report comprises a channel state feedback report associated with a channel state information report identifier having a configuration for physical resource block bundling size reporting.

23. The method of claim 17, further comprising:
receiving, as part of the report, an indication of a channel quality indicator, a precoding matrix indicator, a demodulation reference signal configuration, or any combination thereof, based at least in part on a configured subband size associated with the report.

24. The method of claim 23, wherein the indicated physical resource block bundling size comprises a wideband physical resource block bundling size, and wherein the wideband physical resource block bundling size is interpreted as matching the configured subband size associated with the report.

25. The method of claim 17, wherein a format of the report excludes a channel state information report format that assumes a random precoding for report determination and has a corresponding preconfigured precoding resource block group size for report evaluation.

26. The method of claim 17, wherein the indication of the physical resource block bundling size comprises two or more bits of the report.

27. The method of claim 17, wherein receiving the report comprises:
receiving the report periodically, aperiodically, or semi-persistently.

28. The method of claim 17, wherein the physical resource block bundling size is from a set of physical resource block bundling sizes including at least a two resource block physical resource block bundling size, or a four resource block physical resource block bundling size, and a wideband physical resource block bundling size.

29. The method of claim 17, wherein the physical resource block bundling size is based at least in part on one or more parameters comprising a delay spread of the channel, an input signal-to-interference plus noise ratio, a post-processing signal-to-interference plus noise ratio, a channel estimation error floor, one or more precoding values, a precoding variability, one or more subbands, or any combination thereof.

30. The method of claim 17, wherein the report comprises a channel state feedback report comprising a channel quality indicator, a precoding matrix indicator, a rank indicator, or any combination thereof.

31. The method of claim 30, wherein the channel state feedback report includes an indication of a demodulation reference signal configuration or a demodulation reference signal configuration change request.

32. An apparatus for wireless communication at a user equipment (UE), comprising:
means for determining one or more parameters that indicate channel characteristics of a channel for communicating with a network device;
means for selecting a physical resource block bundling size based at least in part on the determined one or more parameters; and
means for transmitting, to the network device, a report including an indication of the selected physical resource block bundling size.

33-62. (canceled)

63. An apparatus for wireless communication at a user equipment (UE), comprising:
a processor,
memory coupled with the processor; and
instructions stored in the memory and executable by the processor to cause the apparatus to:
determine one or more parameters that indicate channel characteristics of a channel for communicating with a network device;
select a physical resource block bundling size based at least in part on the determined one or more parameters; and
transmit, to the network device, a report including an indication of the selected physical resource block bundling size.

64. An apparatus for wireless communication at a network device, comprising:
a processor,
memory coupled with the processor; and
instructions stored in the memory and executable by the processor to cause the apparatus to:
receive, from a user equipment (UE), a report including an indication of a physical resource block bundling size; and
determine a bundling size of a reference resource associated with a channel state feedback procedure based at least in part on the indication of the physical resource block bundling size.

65. (canceled)

66. (canceled)

67. The apparatus of claim 63, wherein the instructions are further executable by the processor to:
transmit an indication of a UE capability for indicating the physical resource block bundling size, wherein selecting the physical resource block bundling size is based at least in part on the UE capability.
